(19) United States
(12) Patent Application Publication
(10) Pub. No.: US 2023/0092612 A1
(43) Pub. Date: Mar. 23, 2023

(54) Dual-Input Renewable Energy DC Microgrid-Ready Lighting Fixtures

(71) Applicant: BWI Technology LLC, Charlotte, NC (US)

(72) Inventors: Bruce R Roberts, Mentor-on-the-lake, OH (US); Jeffrey Marc Nall, Charlotte, NC (US); Steve McNay, Seymour, TN (US)

(73) Assignee: BWI Technology LLC, Charlotte, NC (US)

(21) Appl. No.: 17/806,663

(22) Filed: Jun. 13, 2022

Related U.S. Application Data
(60) Provisional application No. 63/211,021, filed on Jun. 16, 2021.

(51) Int. Cl. H05B 45/355

(52) U.S. Cl. CPC H05B 45/355

(57) ABSTRACT

A new lighting fixture electronics design is disclosed that is particularly useful for lighting fixtures to utilize energy either directly from the traditional AC power grid or from locally generated renewable DC power sources. The invention entails improvement to the traditional LED driver or lighting ballast design to be able to additionally accept local DC microgrid power directly, without the need to pass the DC power through an external inverter to create an AC voltage. In this way, building construction can be commenced with a single lighting fixture that is capable to operate in multiple input modes, receiving power either from the AC grid or a DC grid, without the need for additional expense required to update the circuitry of the lighting fixtures in the building when the building is upfit at a future date with local renewable energy generating devices.

### FIELD OF INVENTION

This patent disclosure relates generally to an electrical power conditioning device for lighting fixtures and in particular to lighting fixtures capable of receiving both alternating current (AC) and direct current (DC) input.

### BACKGROUND

In recent years, most of the lighting sources that could receive high voltage AC input, such as incandescent or halogen filaments, have been replaced with light emitting diode (LED) technology-based lighting. Additionally, lighting fixtures that used simple transformers and magnetic ballasts to condition the high voltage alternating current, such as linear fluorescent lighting (LFL) and high-intensity discharge (HID) lighting, for their light sources have been replaced by electronic ballasts.

Compared with incandescent lighting technology, LED lighting fixtures are much more efficient at converting electrical energy into light and are much longer lasting for less maintenance of the light source. For these reasons, LED fixtures are being widely adopted as lighting technology. Further, LED lighting has also surpassed LFL and HID lighting in efficiency in many areas where fluorescent and HID lighting had been traditionally the standard. There are lighting application areas where both LFL and HID lighting technology are most appropriate, although making use of higher efficiency electronic ballasts.

Unlike incandescent, halogen, fluorescent, or HID, the light emitting diode is based on solid-state technology that utilizes relatively low voltage direct current to generate light. As an example, driving a voltage in a range between one to four volts (DC), between the anode and cathode of an LED, will allow electrical current to flow through an LED to generate photon emission from the active region of the diode. LEDs, as diodes, only permit electron flow in one direction between the anode and the cathode of the LED itself, therefore requiring a DC voltage to be able to generate light. This DC voltage is referred to as the “forward voltage.” Reversing the polarity of the voltage across the LED will either block the current flow or severely damage the LED itself.

To convert the AC power available from the traditional power grid in most commercial buildings and homes into the low voltage DC needed at the individual LED level to generate light, an electronic power conditioning device is used called an LED driver. The AC power that is typically used to power light fixtures varies by country due to various national grid AC power standards, and by application area. For example, within the United States, commercial buildings may utilize AC voltage that ranges from 208 to 277 volts AC (VAC), or even use 480 VAC to power light fixtures. Using higher voltage enables lower current requirements per fixture, which allows for more lighting fixtures to all be wired to the same branch circuit within the building’s infrastructure. Lowering the total number of lighting circuits within the building reduces the amount of switchgear that is needed for a building, saving cost. The use of 277 VAC, as a voltage commonly available for commercial buildings that have 480 V three-phase service is very common in the United States. Alternatively, 347 VAC is common for lighting fixtures in Canada.

However, within the United States, residential locations typically use different AC voltages than commercial properties for lighting. Lighting fixtures within the home commonly use 120-240 VAC input, as residential energy requirements are much less than a typical commercial or industrial building.

Given these ranges of voltages, LED driver manufacturers commonly make LED drivers capable of receiving AC voltage inputs from 120-277 VAC or from 277-480 VAC nominal voltage ranges of the LED drivers. The LED industry has coined the phrase of a “universal driver” for the 120-277 VAC voltage range and “high-voltage input driver” for the 277-480 VAC input voltage range. Manufacturers need the two separate voltage ranges because it is not economically feasible to serve the entire 120-480 VAC nominal voltage range with one design, as it would unnecessarily burden the cost of components for drivers that only require 120 VAC instead of 480 VAC. An LED driver design is typically optimized for a one of these input voltage ranges. The reason for this is that the range of input has been found to be too large to have acceptable performance to meet standards if attempting to have efficient conversion across a single 120-480 VAC input range.

There are also complexities in designing electronics that can appropriately correct for power-factor within the wide range of input AC voltages along the sinewave of the input power. For AC power, as the current alternates, the voltage polarity reverses and crosses the zero every cycle. Simplistically, as the input voltage nears zero, the current draw from the LED driver would need to approach infinity to maintain constant output power for the LEDs. Therefore, for constant output power to the LEDs, the LED driver needs to account for this cycling so that it does not over-burden the current draw on the system. This is called power factor correction (PFC) with the circuitry present in LED drivers that serves this function called the PFC circuit.

To accommodate the power conversion from high-voltage alternating current (AC), at variable AC input voltages, to the low-voltage direct current (DC) required by the LEDs, each LED driver typically has multiple stages of power conversion.

These basic stages are; (1) converting the AC input voltage to an intermediate DC voltage, (2) providing power factor correction (PFC) of the wattage draw to the AC mains, and (3) converting the intermediate DC voltage to an appropriate DC voltage to driver the forward voltage of the LEDs.

Corporations and utilities are seeking to supplement power currently available from the existing AC power grid with “renewable” power generation and power storage methods. Examples of these methods include photo-voltaic panel arrays that generate DC voltage, fuel cells that generate DC voltage, and storage solutions such as batteries that utilize DC voltage input and output.

There are several patents that disclose LED lighting systems prior art to this invention. Relevant patents are:
U.S. Pat No. 10,154,569 (Harris)
U.S. Pat No. 10,757,773 (Gredler)

### SUMMARY

In accordance with the present invention, a new LED driver design is described that is particularly useful for lighting fixtures to utilize energy either directly from the traditional AC power grid or from locally (on-site) generated DC power sources. The invention entails improvement to the traditional LED driver to be able to accept locally available DC microgrid power directly, without the need to pass the DC power through an external inverter to create an AC voltage.

Many corporations are implementing solar panel installations on their commercial building sites, generating DC power from the panels, feeding the locally generated DC power to the AC grid through use of an inverter, and then running all the devices in their facility from AC power. In this way the power generated from the solar cells is used to offset the power that the local site is using from the grid. The DC power generated from the solar arrays may be in the hundreds of volts, as each solar panel may be placed electrically in series with others to increase the output voltage of the array. This higher voltage DC from panels in series enables higher power transmission distance of wattage generated by the renewable energy devices by reducing wire resistance losses related to current. Higher voltage use enables lower current (Amps) requirement, for the same power transmission. Ideally, solar array output would be up to 600 volts DC, as this is under the voltage rating (600 V) of commonly available commercial wiring present in the electrical construction industry today. Several large commercial solar farms are going even higher up to 1500 V with a proposed 3000 V system in design. These thousands of DC volts buses are not yet common and only seen in huge solar generating stations. Higher voltage DC use also lowers typical in-rush current capacity requirements common on AC systems that happen during electrical start-up sequences as the alternating voltage nears the zero.

There are other future renewable DC power generation or storage options that may be used to generate a DC Microgrid on the premises of a particular site. Solar panels are used as an example, but there may be fuel cell technology, battery storage, or other systems that may convert chemical or mechanical energy into electrical energy.

A more optimal solution would be to use the DC power generated on a specific site directly within the site without the losses of using an inverter to shift from DC to AC, and then back to DC again for equipment, such as LED light fixtures, DC fans, computers, servers, digital devices, electric vehicles, or any other equipment that utilizes DC power to function or to charge batteries for storage using a DC microgrid located within the same site that generates the power, removing the requirement of conversion to AC power prior to consumption. The same system may be used for power demand management to benefit the local utility, controlling the amount of power given to the lighting in trade-off with that given to the battery storage on-site, as a way to reduce AC utility power demands at peak times for the overall facility.

Buildings are being constructed with the infrastructure in place for future renewable DC power generation, battery storage, and electric vehicle DC charging installation. Corporations are planning for renewable energy when constructing new buildings, so that they will not have even more significant costs in the future to move to renewable power generation. For example, requiring the design of a building under construction to have the roof capable of handling the weight of a full solar array on top of the building, even though the solar array will not be installed.

However, in this new construction, as an example, the construction crews are still installing LED lighting fixtures that are only rated to operate on specific AC input voltages and not DC voltage. It is feasible that regulation in the future may require that DC inlet conductors/connectors will be separated from AC, to further sperate power distribution sources, and an electronic driver or ballast may then have to be equipped with separate sets of DC inlet connectors and AC inlet conductors into the same driver housing. This invention reduces the material requirement of replacing an entire fixture when a facility upgrades to renewable energy, to instead only requiring upgrade of hardware at the control panels.

Therefore, there is a need for a driver for LED fixtures that can be used with both Alternating Current (AC) commercially available power and the Direct Current of a solar installation. This need is driven by the desired ability to install “future-proof” LED fixtures. The driver must operate normally on the existing AC input but be able to handle the DC input of a future solar power installation. The future solar installation is envisioned to directly output the DC from the solar panels onto a high voltage DC grid that directly powers the lighting and thus has higher efficiency than many currently available solutions with a multiple of converters. For example, maximum power point tracker (MPPT) circuits, DC to DC, and DC to AC are typical converters/inverters used.

One solution to this challenge is to design a completely new front-end for the LED driver or electronic ballast. In one embodiment, this front-end rectifier section employs a sense circuit that detects the DC input and then uses a pair of relays, or switches, to bypass the input rectifiers. This solution would increase efficiency because the bypass switches can provide ultra-low voltage drop (their resistance is <0.05 ohms) and thus reduce the power normally wasted by the diode bridge circuit. A typical diode bridge consists of 4 diodes with each dropping approximately one volt such that two are conducting in each half cycle. Thus, a 200 W driver operating at 120 VAC would gain a savings of 3.3 Watts if the proposed bypass system were in place. If the facility intends to actively switch, without shutting down the LED driver or electronic ballast for a brief time period of at least one AC cycle, from use of AC to DC during daily operation of the ballast or driver, then AC input requires a synchronized shut-down mode under a DC input sensing process, bringing input through an acceptable polarity reversal (zero crossing). The DC input voltage may be applied to the AC input voltage and sensed as offset. Another way of applying these connections for bridge bypass or PFC bypass is by active rectifiers/switch (such as FET device). Switch conduction is much better than the rectifiers themselves in a bridge.

A second solution to the challenge is to increase the current rating of two of the existing diodes that are conducting in the DC system. In the DC operation mode, only two of the four diodes are under load. The remaining two diodes are not conducting any current. Alternately, all 4 diodes could be made larger in current handling capacity to solve the issue of higher average current in DC operation. This solution of increasing the current rating of the two DC mode diodes or all four concurrently is the most straight forward for a manufacturer to produce a SKU that can be evaluated by a safety agency and then sold as a “solar ready” product (along with verifying voltage and current rating of all parts utilized). Additionally, the thermal switch and other safety protection components are chosen to be rated for DC operation. The increased rating requirement is contrary to prior design teachings of diode selection for AC input LED driver electronics or electronic ballast design, as the increased rating will increase the cost of the diodes over the lower cost of a diode with ratings required by the typical root-mean-squared (RMS) AC input voltage range. However, this increased cost is a relatively low percentage of the overall total cost of the LED driver when considering the scope of investment needed to change drivers completely to be able to use locally generated renewable energy. Alternatively, installing an inverter to use the locally generated power to convert to AC for the fixtures will incur wasteful energy conversion losses. This new labeled product (“S” label as a branding example) could then be safely used by anyone attempting to upgrade their fixtures in advance, or alongside, of a solar installation.

A third solution would be to bypass not only the rectification circuit but the entire PFC section of the driver design. If the input DC voltage is from a stable source, such as a battery or regulated DC bus, there is no need for a PFC section to provide a regulated DC input to the second stage. The second stage would then be stand alone and would perform its normal voltage and current regulation depending on load conditions. The second stage is also where isolation occurs if necessary, so removing the PFC would not affect isolation status. Removing the PFC section as a whole stage would have a significant LED driver efficiency improvement.

### BRIEF DESCRIPTION OF THE DRAWINGS

FIG. 1 is an example of a block diagram of the electrical operation of a typical LED driver that is prior art for power conversion from AC input to DC output.

FIG. 2 is a decision tree that can be used to calculate the increased current rating required for the input diodes within the rectification circuit on the input of the driver to allow for high voltage DC input operation.

FIG. 3 is a decision tree that can be used to calculate the increased reverse voltage rating required for the input diodes within the rectification circuit on the input of the driver to allow for high voltage DC input operation.

FIG. 4 is a block diagram of an example of a sense circuit that detects the DC input and then uses a pair of relays or switches to bypass the input voltage rectifier circuit.

FIG. 5. is a block diagram of an LED driver with input capability to bypass not only the rectification circuit but the entire PFC section if the input DC sensed is from a stable source such as a battery or regulated DC bus.

### DETAILED DESCRIPTION OF THE DRAWINGS

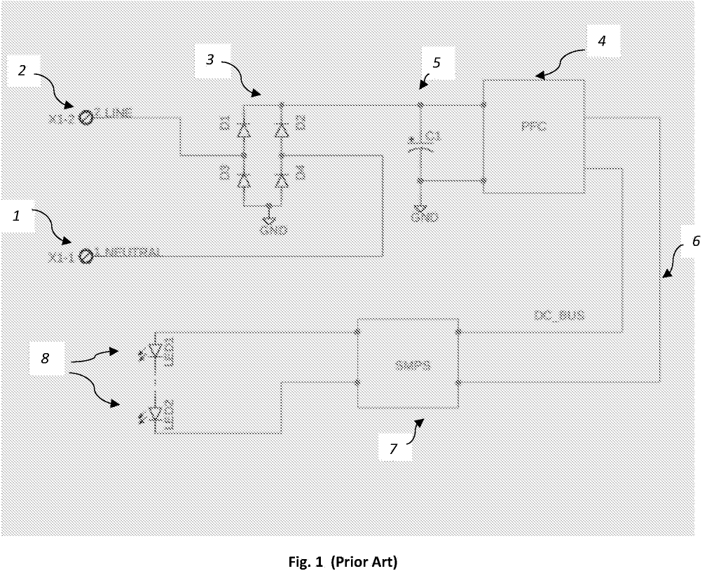

FIG. 1 is an example of the electrical operation of most LED drivers that are manufactured within the lighting industry. LED drivers are used to convert the mains AC input voltage into a well-regulated DC voltage that is useful to drive LED arrays. The LEDs may be arranged electrically in series, parallel, or series parallel configurations to achieve a wide range of LED driver output voltages. The mains AC input is received by the driver by electrically connecting the line voltage (2) and the neutral wire (1) of the AC branch circuit in the building used to power the lighting fixture. The AC power is converted to a DC input through use of a rectifier that comprises a diode bridge formed such that electrons will only flow one way into the Power Factor Correction (PFC) circuit (4). Typically, there is a capacitor (5) electrically tied across the DC input leads to the PFC circuit that acts as a filter to smooth the DC voltage.

The output of the PFC circuit is called the DC Bus (6) that is a regulated DC input into the switched-mode-power-supply (SMPS) (7). The DC Bus (6) is typically in hundreds of volts DC, as it is derived from the PFC (4) conditioning the AC mains input voltage. The SMPS (7) reduces the higher voltage of the DC Bus to the appropriate voltage needed by the LEDs (8) electrically in a series, parallel, or series parallel configuration.

This invention includes the design calculation used to determine the current carrying requirement for the diodes that are needed within the diode bridge rectification circuit (3) so that the appropriate diodes may be selected for an LED driver design that can receive either high voltage AC mains input (in the range between 90 VAC and 480 VAC nominal input) or DC voltage input (120 VDC to 600 VDC). The limit for the DC input current should not be construed as to be limited to 600 VDC for this invention, as this circuit will work with thousands of volts input. However common commercial jacketed wiring used within commercial buildings for the AC mains was manufactured with a rating and testing to only 600 V. Therefore, until wiring for DC microgrids become specifically prevalent, the standard for max VDC transmission within buildings will most likely stay at 600 VDC or below.

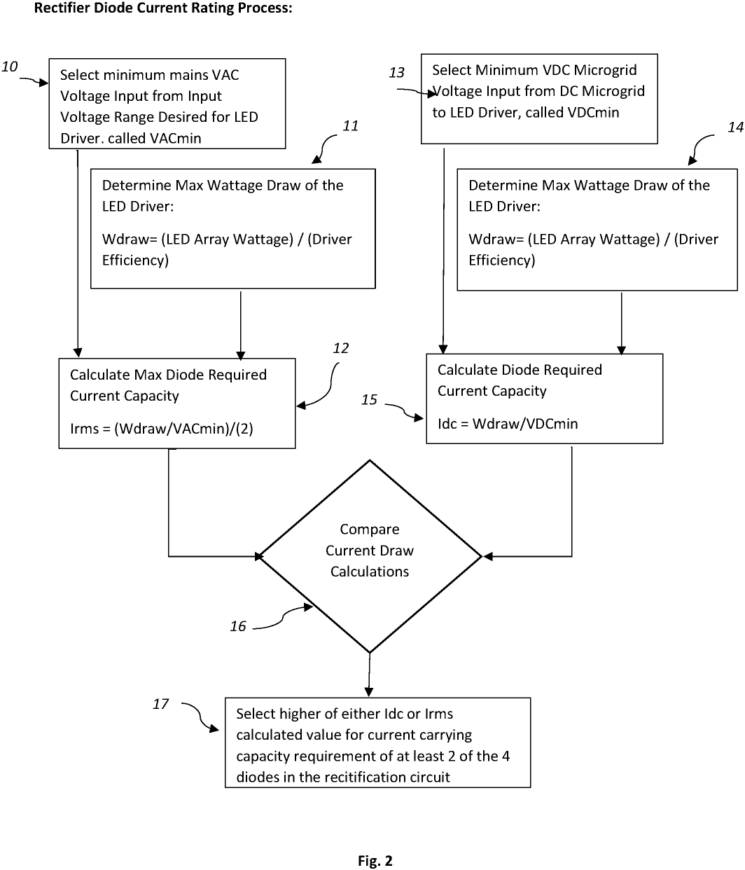

The calculations for diode sizing need to be carried out for both AC input, and separately performed for DC input requirements. FIG. 2 illustrates the calculation requires to size the current carrying capacity of the diodes properly for the AC and DC input to the same LED driver. First, the minimum AC voltage input expected for the LED driver (10) is defined. It should be noted that this value is for the nominal AC voltage which is a root-mean-squared (RMS) value of the AC voltage. Further, the input ratings for LED drivers and electronic ballasts often account for power grid line quality variation, adding +/- 10 percent to all nominal values. Therefore, if the VAC minimum is intended to be 110 Vrms, the true value used for design is 99 Vrms. Next, the total input wattage draw of the LED driver is calculated (11) considering the conversion efficiency of the driver and the wattage required on the output of the driver by the LED array or light source. Next, to determine the current capacity that will be required of the diodes (12) the wattage draw is divided by the minimum input AC voltage, and then further divided by a factor of two. The division in half is due to the presence of two diodes conducting current for AC input voltage within the diode rectification bridge, although both diodes are only conducting for half the time. Then the minimum DC voltage that may be applied as input to the LED driver is selected (13). For example, if portions of the solar array are down for maintenance, the voltage stack-up of the array may not stay constant within the system over time. There may also be variability in the voltage output of the solar array by site due to physical configuration changes, so the intent of the LED driver design may be to accommodate a wider range of DC inputs. The max wattage draw of the driver with a DC input is determined (14) by dividing the output wattage required for the LED array by the driver efficiency to calculate the input wattage draw requirement. Then the current carrying capacity calculation of the diodes in the DC input mode (15) is the wattage draw divided by the lowest input DC voltage anticipated from the DC microgrid. After calculating the AC input amp draw (12) and the DC input amp draw (15) the two values are compared (16) to determine the highest number. The highest number between either the AC or DC operation mode is used (17) to specify the current rating of the diode needed for the single diode rectification circuit employed for both AC and DC input modes.

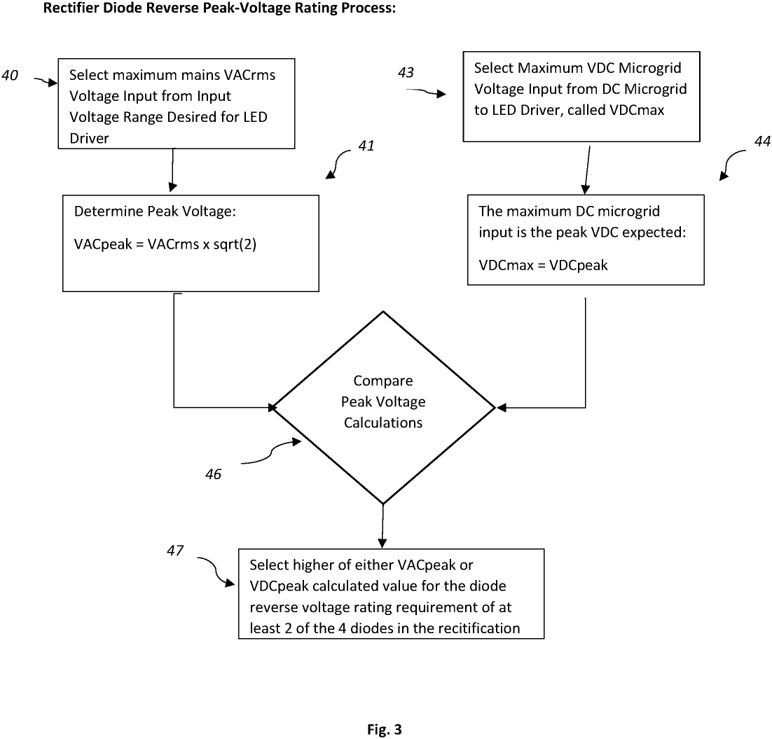

FIG. 3 is a demonstration of the calculation used to determine the Reverse Peak-Voltage rating of at least 2 of the 4 diodes employed within the diode rectification circuit. For diodes, the reverse peak voltage is a rating to denote the amount of voltage that the diode will need to withstand when experiencing a reverse bias in the circuit. While on might assume this only applies to the circuit when in AC input mode, this is a concern for DC input mode as well, as the installer may accidentally flip polarity on the input leads for the DC input. Without the proper rating, this could damage the diodes if not rated with a high enough reverse voltage peak. For sizing the AC reverse voltage peak, first it is needed to select the maximum mains input (40) from the input voltage range expected for the lighting fixture. If the maximum voltage selected in a nominal voltage, then to account for variation on the power grid an adder of 10% may also be added to the value. Then, as these AC voltages are commonly expressed in RMS voltage terms, the peak value is calculated by multiplying by the square-root of 2. For example, if a light fixture intends to have the top of the nominal AC input range as 277 VAC, then accounting for power grid variation gives a design value of 305 VAC. To convert 305 AC to a peak value requires multiplying by 1.414, which gives a voltage peak value of 431 V. For DC input mode, the maximum VDC anticipated for the LED driver (43) should be selected. Typically, this could be up to 600 VDC if employing common commercial building wiring infrastructure, although with usage of bus bars or other techniques could be at thousands of volts. The maximum input volts anticipated from the local DC microgrid is equivalent to the voltage peak value anticipated (44) for peak reverse voltage calculation. Next, comparing the two calculated voltage peak values (45) is performed to select the highest peak voltage (47) to set the minimum reverse voltage rating for at least 2 of the 4 diodes in the rectification bridge circuit.

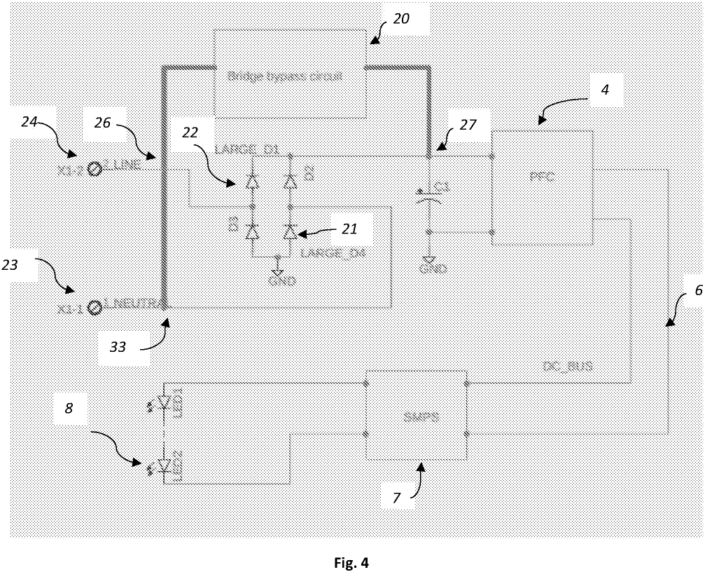

FIG. 4 is a of an example of an updated diode rectification bridge, using the calculations from FIG. 2 and FIG. 3 to size the diodes (21,22) appropriately to be able to accommodate either AC voltage mains input or a high voltage DC microgrid input. FIG. 4 also illustrates a sensing circuit (20) that detects the DC input and then uses a pair of relays or switches to bypass the input voltage rectifier circuit. The two voltage input lines (23,24) are used for dual mode input, either AC or DC voltage into the circuit. In AC input mode the AC line (23) and the AC neutral (24) are connected electrically to the driver. When operating in DC mode, one of the input lines (23,24) may be connected to high voltage DC (positive polarity) and the other to high voltage DC (negative polarity). The bridge bypass circuit (20) functions to monitor the voltage across the input AC line (26) and the input AC neutral connection (33) for the presence of oscillating voltage. If the bypass sense circuit (20) senses voltage without oscillation, the circuit will direct the voltage directly into the PFC circuit (4) and the filter capacitor (27). This bypass then increases the efficiency by bypassing the losses of the rectification diode bridge (3).

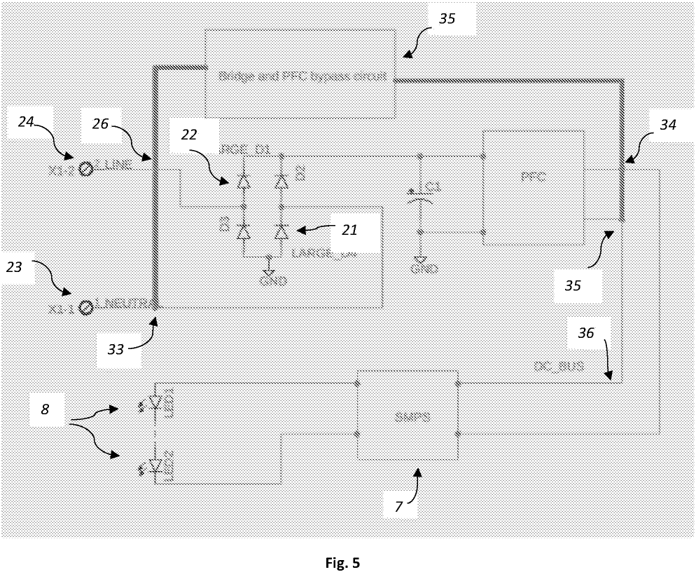

FIG. 5 is an alternate embodiment where the bridge-and-PFC bypass circuit (35) is connected to the input leads (23,24) of the LED driver circuit, to monitor voltage at prior to input into the rectification to monitor the voltage across the input AC line (26) and the input AC neutral connection (33) for the presence of oscillating voltage. If the bridge-and-PFC bypass circuit (35) senses voltage without oscillation, the circuit will determine the voltage is coming directly from the local DC microgrid as a well-regulated DC source and connect electrically directly to the internal DC bus (36) of the driver across the positive and negative DC connections (34,35) out of the PFC circuit. In this way, the local DC microgrid voltage becomes the internal DC bus (36) voltage and is fed directly into the SMPS circuit (7).

What is claimed is:

1. An electronic power conditioning device for lighting, comprising:
a circuit for converting the AC input voltage to an intermediate DC voltage,
a power factor correction (PFC) circuit of the wattage draw to the AC mains, and
a circuit converting the intermediate DC voltage to an appropriate DC voltage for a light source, wherein the conversion from AC input voltage to an intermediate DC voltage consists of four diodes, and
wherein at least two of the diodes in the circuit for converting the AC input voltage to an intermediate DC voltage are rated for current in excess of the total input wattage draw divided by the minimum rated root-mean-square voltage.

2. The electronic power conditioning device for lighting in claim 1, wherein the circuit for converting the AC input voltage to an intermediate DC voltage comprises four diodes arranged in an electrical bridge design.

3. The electronic power conditioning device for lighting in claim 1, wherein the output voltage of the circuit is DC voltage to drive the forward voltage of an LED array.

4. The electronic power conditioning device for lighting, defined in claim 1, wherein the light source is a light emitting diode (LED) array that are electrically in series-parallel configuration.

5. The electronic power conditioning device for lighting, defined in claim 1, wherein the rated AC input voltage range includes voltages in the 120 VAC-240 VAC range and for the same input circuit the rated DC input range includes any voltages in the 375 VDC to 600 VDC range.

6. The electronic power conditioning device for lighting in claim 1, wherein the input voltage to the device may be either from an alternating current or direct current source.

7. An electronic power conditioning device for lighting, comprising:
a rectifier circuit for converting AC input voltage to an intermediate DC voltage,
a power factor correction (PFC) circuit of the wattage draw to the AC mains, and
a circuit converting the intermediate DC voltage to an appropriate DC voltage to drive the light source, and
a sense circuit that detects the DC input,
wherein the sense circuit connects to the input of the power factor correction circuit to provide an electrical connection when DC input voltage is present on the input connection.

8. The electronic power conditioning device for lighting in claim 7, wherein the sense circuit monitors the input leads for voltage oscillation to detect the input voltage mode.

9. The electronic power conditioning device for lighting in claim 7, wherein the sense circuit monitors the input leads for stable voltage to detect the input voltage mode.

10. The electronic power conditioning device for lighting in claim 9, wherein the sense circuit comprises a relay to electrically bypass the input rectifiers.

11. The electronic power conditioning device for lighting in claim 9, wherein the sense circuit comprises a switch to electrically bypass the input rectifiers.

12. The electronic power conditioning device for lighting in claim 7, wherein the input voltage to the device may be either from an alternating current or direct current source.

13. An electronic power conditioning device for lighting, comprising:
a rectifier circuit converting AC input voltage to an intermediate DC voltage,
a power factor correction (PFC) circuit of the wattage draw to the AC mains,
a circuit converting the intermediate DC voltage to an appropriate DC voltage to driver the forward voltage of an LED array,
a sense circuit that detects the DC input, and
wherein the sense circuit electrical connects to the input of circuit converting the intermediate DC voltage to an appropriate output voltage to drive the light source, to provide the DC input detected on the input leads directly into the circuit converting the intermediate DC voltage to an appropriate DC voltage for the output.

14. The electronic power conditioning device for lighting in claim 13, wherein the output voltage of the circuit is DC voltage to drive the forward voltage of an LED array.

15. The electronic power conditioning device for lighting in claim 13, wherein the input voltage to the lighting fixture is provided from a regulated DC bus.

16. The electronic power conditioning device for lighting in claim 13, wherein the input voltage to the lighting fixture is provided from a storage battery as the source of energy.

17. The electronic power conditioning device for lighting in claim 13, wherein the circuit converting the intermediate DC voltage to an appropriate output voltage to drive the light source is electrically isolated from the input voltage.

18. The electronic power conditioning device for lighting in claim 13, wherein the input voltage to the device may be either from an alternating current or direct current source.

19. The electronic power conditioning device for lighting in claim 13, wherein the sense circuit monitors the input leads for stable voltage to detect the input voltage mode.

20. The electronic power conditioning device for lighting in claim 19, wherein the sense circuit comprises a relay to electrically bypass the input rectifiers.

21. The electronic power conditioning device for lighting in claim 19, wherein the sense circuit comprises a switch to electrically bypass the input rectifiers.
